(19) United States
(12) Patent Application Publication
(10) Pub. No.: US 2021/0235006 A1
(43) Pub. Date: Jul. 29, 2021

(54) IMAGING DEVICE AND IMAGING METHOD

(71) Applicant: FUJIFILM Corporation, Tokyo (JP)

(72) Inventor: Shuji ONO, Tokyo (JP)

(73) Assignee: FUJIFILM Corporation, Tokyo (JP)

(21) Appl. No.: 17/227,371

(22) Filed: Apr. 11, 2021

Related U.S. Application Data
(63) Continuation of application No. PCT/JP2019/040487, filed on Oct. 15, 2019.

(30) Foreign Application Priority Data
Oct. 22, 2018 (JP) 2018-198457

(51) Int. Cl. H04N 5/235; G06T 5/50

(52) U.S. Cl. CPC H04N 5/2352; G02B 5/3025; G06T 5/50

(57) ABSTRACT

Provided are an imaging device and an imaging method that can generate images between which a difference in appearance caused by a difference between the polarization directions of received light is suppressed in a case in which different images are generated on the basis of light having different polarization directions. An imaging device (1) includes: an imaging optical system (10); a polarizer (12) that aligns a polarization direction of light transmitted through a first pupil region (E1) and a second pupil region (E2) with a first polarization direction; a first optical rotator (14) that rotates the light, which has been transmitted through the second pupil region (E2) and has been aligned in the first polarization direction, in a second polarization direction different from the first polarization direction; an imaging element (100) that receives the light transmitted through the first pupil region and the second pupil region; and an image generation unit that generates a first image corresponding to the light transmitted through the first pupil region and a second image corresponding to the light transmitted through the second pupil region.

### CROSS-REFERENCE TO RELATED APPLICATIONS

The present application is a Continuation of PCT International Application No. PCT/JP2019/040487 filed on Oct. 15, 2019 claiming priority under 35 U.S.C § 119(a) to Japanese Patent Application No. 2018-198457 filed on Oct. 22, 2018. Each of the above applications is hereby expressly incorporated by reference, in its entirety, into the present application.

### BACKGROUND OF THE INVENTION

### 1. Field of the Invention

The present invention relates to an imaging device and an imaging method, and more particularly, to an imaging device and an imaging method that independently acquire a plurality of images with one imaging element.

### 2. Description of the Related Art

In the related art, a technique has been proposed in which light in two different polarization directions is acquired by different pixels to acquire two independent images.

For example, JP2009-169096A discloses a technique in which light in two different polarization directions is received by different pixels to acquire two independent images. A light receiving element described in JP2009-169096A comprises an analyzer array that transmits light transmitted through a polarizer of a polarizing plate, and each image corresponding to light in different polarization directions received by the light receiving element is generated.

### SUMMARY OF THE INVENTION

Here, in the technique described in JP2009-169096A, the images corresponding to the light in different polarization directions are generated. However, two types of light in different polarization directions are generated without aligning the polarization directions even once. Specifically, in JP2009-169096A, first, light transmitted through a lens is transmitted through a polarizing plate that transmits lights having two types of polarization directions to generate two types of light having different polarization directions. Then, the two types of light having different polarization directions are transmitted through an analyzer and are received by the light receiving element. Therefore, in the imaging device described in JP2009-169096A, two types of light having different polarization directions are generated without aligning the polarization directions even once, and each image is generated on the basis of the light.

As such, in a case in which images are generated on the basis of light having different polarization directions without aligning the polarization directions even once, the following problems may occur.

For example, a technique is known which captures an image of a water surface at the Brewster's angle using a polarization filter to shield s-polarized light. However, in a case in which light having different polarization directions is generated from the beginning, one polarization direction can be aligned with a direction in which the s-polarized light is shielded, but it is difficult to align the other polarization direction with the direction in which the s-polarized light is shielded.

In addition, a technique is known which estimates the sugar content of fruits using spectral reflectance. However, in a case in which images based on light having different polarization directions are used without aligning the polarization directions even once, the spectral reflectance may not be calculated properly. Specifically, in the images based on the light having different polarization directions which have been obtained without aligning the polarization directions even once, for a high glossy portion of the object, the number of specular reflected light components is large, and the correct spectral reflectance is not obtained.

Further, for example, in the generation of a parallax image, in a case in which the polarization directions are not aligned even once, the erroneous detection of the amount of parallax is likely to occur due to the difference in appearance between images. Specifically, in a case in which a parallax image is generated for a glossy object on the basis of light having different polarization directions, gloss is suppressed in a region matched with the Brewster's angle in one image, and the gloss is not suppressed in the other image. As a result, a large difference in appearance between both images may occur, and the erroneous detection of the amount of parallax may occur.

The invention has been made in view of the above-mentioned problems, and an object of the invention is to provide an imaging device and an imaging method that can generate images between which a difference in appearance caused by a difference between the polarization directions of received light is suppressed in a case in which different images are generated on the basis of light having different polarization directions.

According to an aspect of the invention, there is provided an imaging device comprising: an imaging optical system that has a pupil region including a first pupil region and a second pupil region different from the first pupil region; a polarizer that aligns a polarization direction of light transmitted through the first pupil region and the second pupil region with a first polarization direction; a first optical rotator that rotates the light, which has been transmitted through the second pupil region and has been aligned in the first polarization direction, in a second polarization direction different from the first polarization direction; an imaging element that receives the light transmitted through the first pupil region and the second pupil region and has a plurality of pixel units each of which is a set of a first pixel and a second pixel receiving light in different polarization directions; and an image generation unit that performs a crosstalk removal process on pixel signals of the first pixel and the second pixel and generates a first image corresponding to the light transmitted through the first pupil region and a second image corresponding to the light transmitted through the second pupil region on the basis of the pixel signals subjected to the crosstalk removal process.

According to this aspect, the polarizer aligns the polarization direction of the light transmitted through the first pupil region and the second pupil region with the first polarization direction, and the first optical rotator rotates the light in the first polarization direction, which has been transmitted through the second pupil region, in the second polarization direction different from the first polarization direction. In this way, each image corresponding to the first polarization direction and the second polarization direction is generated. Therefore, according to this aspect, even in a case in which different images are generated on the basis of light having different polarization directions, it is possible to generate the images between which the difference in appearance caused by the difference between the polarization directions of the received light is suppressed.

Preferably, the imaging device further comprises a second optical rotator that rotates the light, which has been transmitted through the first pupil region and has been aligned in the first polarization direction, in a third polarization direction different from the first polarization direction and the second polarization direction.

According to another aspect of the invention, there is provided an imaging device comprising: an imaging optical system that has a pupil region including a first pupil region and a second pupil region different from the first pupil region; a polarizer that aligns a polarization direction of light transmitted through the first pupil region and the second pupil region with a first polarization direction; a first optical rotator that rotates the light, which has been transmitted through the second pupil region and has been aligned in the first polarization direction, in a second polarization direction orthogonal to the first polarization direction; an imaging element that receives the light transmitted through the first pupil region and the second pupil region and has a plurality of pixel units each of which is a set of a first pixel receiving light in the first polarization direction and a second pixel receiving light in the second polarization direction; and an image generation unit that generates a first image corresponding to the light transmitted through the first pupil region and a second image corresponding to the light transmitted through the second pupil region on the basis of pixel signals of the first pixel and the second pixel.

According to this aspect, the polarizer aligns the polarization direction of the light transmitted through the first pupil region and the second pupil region with the first polarization direction, and the first optical rotator rotates the light, which has been transmitted through the second pupil region and has been aligned in the first polarization direction, in the second polarization direction orthogonal to the first polarization direction. In this way, each image corresponding to the first polarization direction and the second polarization direction is generated. Therefore, according to this aspect, even in a case in which different images are generated on the basis of light having different polarization directions, it is possible to generate the images between which the difference in appearance caused by the difference between the polarization directions of the received light is suppressed.

Preferably, the imaging device further comprises: a first wavelength filter that transmits light in a first wavelength band in the light transmitted through the first pupil region; and a second wavelength filter that transmits light in a second wavelength band in the light transmitted through the second pupil region.

According to still another aspect of the invention, there is provided an imaging device comprising: an imaging optical system that has a pupil region including a first pupil region, a second pupil region different from the first pupil region, and a third pupil region different from the first and second pupil regions; a polarizer that aligns a polarization direction of light transmitted through the first pupil region, the second pupil region, and the third pupil region with a first polarization direction; a first optical rotator that rotates the light, which has been transmitted through the second pupil region and has been aligned in the first polarization direction, in a second polarization direction different from the first polarization direction; a second optical rotator that rotates the light, which has been transmitted through the third pupil region and has been aligned in the first polarization direction, in a third polarization direction different from the first polarization direction and the second polarization direction; an imaging element that receives the light transmitted through the first pupil region, the second pupil region, and the third pupil region and has a plurality of pixel units each of which is a set of a first pixel, a second pixel, and a third pixel receiving light in different polarization directions; and an image generation unit that performs a crosstalk removal process on pixel signals of the first pixel, the second pixel, and the third pixel and generates a first image corresponding to the light transmitted through the first pupil region, a second image corresponding to the light transmitted through the second pupil region, and a third image corresponding to the light transmitted through the third pupil region on the basis of the pixel signals subjected to the crosstalk removal process.

According to this aspect, the polarizer aligns the polarization direction of the light transmitted through the first pupil region, the second pupil region, and the third pupil region with the first polarization direction. The first optical rotator rotates the light, which has been transmitted through the second pupil region and has been aligned in the first polarization direction, in the second polarization direction different from the first polarization direction. The second optical rotator rotates the light, which has been transmitted through the third pupil region and has been aligned in the first polarization direction, in the third polarization direction different from the first polarization direction and the second polarization direction. Therefore, according to this aspect, even in a case in which different images are generated on the basis of light having different polarization directions, it is possible to generate the images between which the difference in appearance caused by the difference between the polarization directions of the received light is suppressed.

Preferably, the imaging device further comprises a third optical rotator that rotates the light, which has been transmitted through the first pupil region and has been aligned in the first polarization direction, in a fourth polarization direction different from the first polarization direction, the second polarization direction, and the third polarization direction.

Preferably, the imaging device further comprises: a first wavelength filter that transmits light in a first wavelength band in the light transmitted through the first pupil region; a second wavelength filter that transmits light in a second wavelength band in the light transmitted through the second pupil region; and a third wavelength filter that transmits light in a third wavelength band in the light transmitted through the third pupil region.

Preferably, the polarizer shields s-polarized light.

Preferably, in the imaging element, the pixel unit includes a pixel including a polarization element.

Preferably, in the imaging element, the polarization element is provided between a photodiode and a microlens which constitute the pixel.

According to yet another aspect of the invention, there is provided an imaging method comprising: a step of causing a polarizer to align a polarization direction of light transmitted through a first pupil region and a second pupil region of an imaging optical system, which has a pupil region including the first pupil region and the second pupil region different from the first pupil region, with a first polarization direction; a step of causing a first optical rotator to rotate the light, which has been transmitted through the second pupil region and has been aligned in the first polarization direction, in a second polarization direction different from the first polarization direction; and a step of performing a crosstalk removal process on pixel signals of a first pixel and a second pixel of an imaging element, which receives the light transmitted through the first pupil region and the second pupil region and has a plurality of pixel units each of which is a set of the first pixel and the second pixel receiving light in different polarization directions, and generating a first image corresponding to the light transmitted through the first pupil region and a second image corresponding to the light transmitted through the second pupil region on the basis of the pixel signals subjected to the crosstalk removal process.

Preferably, a second optical rotator rotates the light, which has been transmitted through the first pupil region and has been aligned in the first polarization direction, in a third polarization direction different from the first polarization direction and the second polarization direction.

According to still yet another aspect of the invention, there is provided an imaging method comprising: a step of causing a polarizer to align a polarization direction of light transmitted through a first pupil region, a second pupil region, and a third pupil region of an imaging optical system, which has a pupil region including the first pupil region, the second pupil region different from the first pupil region, and the third pupil region different from the first and second pupil regions, with a first polarization direction; a step of causing a first optical rotator to rotate the light, which has been transmitted through the second pupil region and has been aligned in the first polarization direction, in a second polarization direction different from the first polarization direction; a step of causing a second optical rotator to rotate the light, which has been transmitted through the third pupil region and has been aligned in the first polarization direction, in a third polarization direction different from the first polarization direction and the second polarization direction; and a step of performing a crosstalk removal process on pixel signals of a first pixel, a second pixel, and a third pixel of an imaging element, which receives the light transmitted through the first pupil region, the second pupil region, and the third pupil region and has a plurality of pixel units each of which is a set of the first pixel, the second pixel, and the third pixel receiving light in different polarization directions, and generating a first image corresponding to the light transmitted through the first pupil region, a second image corresponding to the light transmitted through the second pupil region, and a third image corresponding to the light transmitted through the third pupil region on the basis of the pixel signals subjected to the crosstalk removal process.

Preferably, a third optical rotator rotates the light, which has been transmitted through the first pupil region and has been aligned in the first polarization direction, in a fourth polarization direction different from the first polarization direction, the second polarization direction, and the third polarization direction.

According to yet still another aspect of the invention, there is provided an imaging method comprising: a step of causing a polarizer to align a polarization direction of light transmitted through a first pupil region and a second pupil region of an imaging optical system, which has a pupil region including the first pupil region and the second pupil region different from the first pupil region, with a first polarization direction; a step of causing a first optical rotator to rotate the light, which has been transmitted through the second pupil region and has been aligned in the first polarization direction, in a second polarization direction orthogonal to the first polarization direction; and a step of generating a first image corresponding to the light transmitted through the first pupil region and a second image corresponding to the light transmitted through the second pupil region on the basis of pixel signals of a first pixel and a second pixel of an imaging element which receives the light transmitted through the first pupil region and the second pupil region and has a plurality of pixel units each of which is a set of the first pixel receiving light in the first polarization direction and the second pixel receiving light in the second polarization direction.

According to the invention, it is possible to generate the images between which the difference in appearance caused by the difference between the polarization directions of the received light is suppressed even in a case in which different images are generated on the basis of light having different polarization directions.

### BRIEF DESCRIPTION OF THE DRAWINGS

FIG. 1 is a diagram illustrating a schematic configuration of an imaging device.

FIG. 2 is a front view illustrating a schematic configuration of a polarizer.

FIG. 3 is a front view illustrating a schematic configuration of an optical rotator.

FIG. 4 is a diagram illustrating an example of a first polarization direction and a second polarization direction.

FIG. 5 is a diagram illustrating a schematic configuration of an imaging element.

FIG. 6 is a cross-sectional view illustrating a schematic configuration of one pixel.

FIG. 7 is a diagram illustrating an example of the arrangement pattern of polarization elements.

FIG. 8 is a diagram illustrating a configuration of one unit of the polarization elements.

FIG. 9 is a diagram illustrating an example of the arrangement of pixels in the imaging element.

FIG. 10 is a block diagram illustrating a schematic configuration of a signal processing unit.

FIG. 11 is a conceptual diagram illustrating image generation.

FIGS. 12A and 12B are diagrams illustrating an example of the calculation of a matrix A.

FIGS. 13A and 13B are diagrams illustrating an example of the calculation of the matrix A.

FIGS. 14A and 14B are diagrams illustrating an example of the calculation of the matrix A.

FIG. 15 is a flowchart illustrating a processing flow of an imaging method.

FIG. 16 is a diagram illustrating a schematic configuration of an imaging device.

FIG. 17 is a front view illustrating a schematic configuration of a wavelength filter.

FIG. 18 is a diagram illustrating a schematic configuration of an imaging device.

FIG. 19 is a front view illustrating a conceptual pupil region of an imaging optical system.

FIG. 20 is a front view illustrating a schematic configuration of an optical rotator.

FIGS. 21A and 21B are diagrams illustrating an example of the calculation of the matrix A.

FIGS. 22A and 22B are diagrams illustrating an example of the calculation of the matrix A.

FIG. 23 is a flowchart illustrating a processing flow of an imaging method.

FIG. 24 is a diagram illustrating a schematic configuration of an imaging device.

FIG. 25 is a diagram illustrating a schematic configuration of an imaging device.

### DESCRIPTION OF THE PREFERRED EMBODIMENTS

Hereinafter, preferred embodiments of the invention will be described in detail with reference to the accompanying drawings.

### First Embodiment

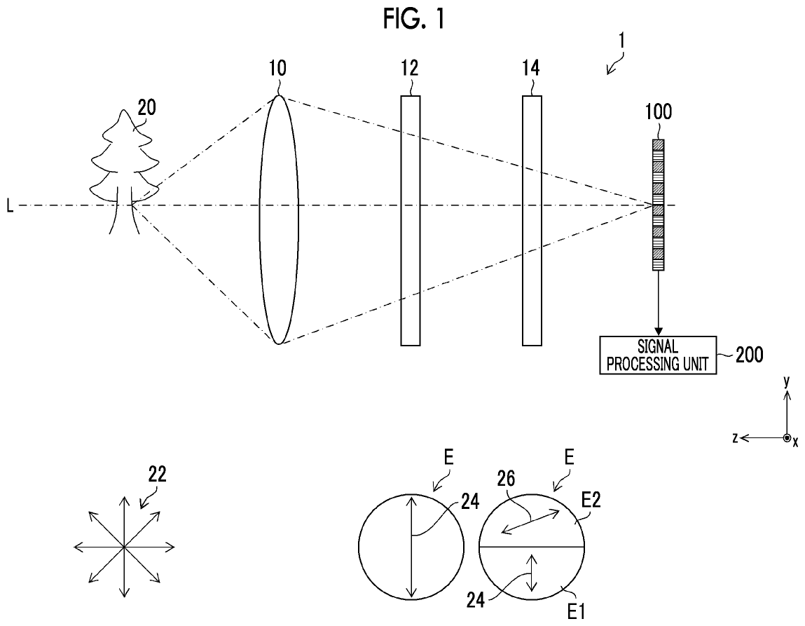

FIG. 1 is a diagram illustrating a schematic configuration of an imaging device 1 according to a first embodiment. In this embodiment, two independent images are acquired by using two different polarization directions (a first polarization direction 24 and a second polarization direction 26).

As illustrated in FIG. 1, an imaging device 1 according to this embodiment comprises an imaging optical system 10, a polarizer 12, an optical rotator (first optical rotator) 14, an imaging element 100, and a signal processing unit 200. Further, in FIG. 1, a polarization direction 22 of natural light reflected by an object 20, the first polarization direction 24 which is the polarization direction of light transmitted through the polarizer 12, and the second polarization direction 26 which is the polarization direction of light transmitted through the optical rotator 14 are illustrated below the polarizer 12 and the optical rotator 14 together with a pupil region E of the imaging optical system 10.

Light reflected by the object 20 includes all of the polarization directions 22. This light is captured by the imaging optical system 10. The pupil region E of the imaging optical system 10 includes a first pupil region E1 and a second pupil region E2. The first pupil region E1 and the second pupil region E2 can be determined in any manner. For example, as illustrated in FIG. 1, the pupil region E may be divided into two regions in the vertical direction. One of the two regions may be the first pupil region E1 and the other of the two regions may be the second pupil region E2. In this case, a parallax image can be obtained from an image based on light transmitted through the first pupil region E1 and an image based on light transmitted through the second pupil region E2. Further, for example, the pupil region E may be divided into two regions in the horizontal direction orthogonal to the vertical direction. One of the two regions may be the first pupil region E1 and the other of the two regions may be the second pupil region E2.

The light transmitted through the first pupil region E1 and the second pupil region E2 is incident on the polarizer 12 which is provided at a pupil position or near the pupil position and is transmitted through the polarizer 12. The polarization direction of the light transmitted through the first pupil region E1 and the second pupil region E2 is aligned with the first polarization direction 24 by the polarizer 12. Then, the polarization direction of a portion of the light is changed from the first polarization direction 24 to the second polarization direction 26 by the optical rotator 14 provided in a half pupil region (the first pupil region E1 or the second pupil region E2) which is the half of the pupil region E. Then, the imaging element 100 receives the light in the first polarization direction 24 and the light in the second polarization direction 26.

[Polarizer]

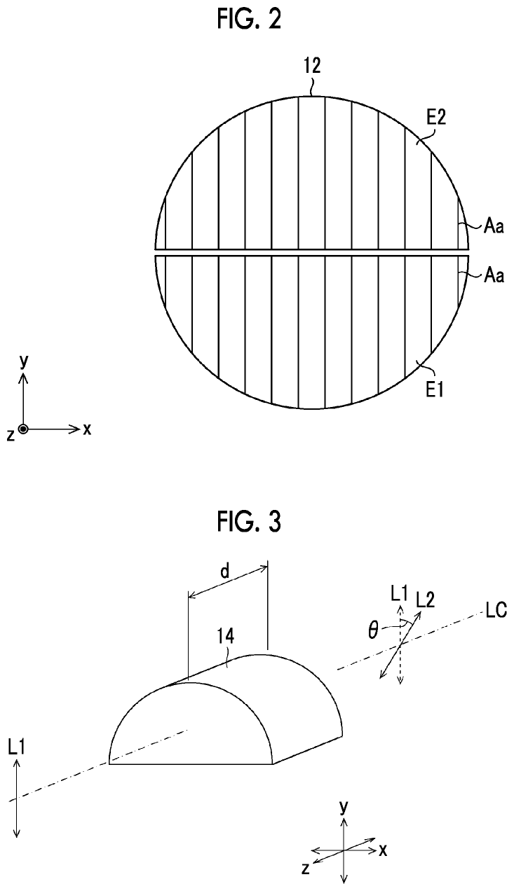

FIG. 2 is a front view illustrating a schematic configuration of the polarizer 12. As illustrated in FIG. 1, the polarizer 12 is provided at or near the pupil position of the imaging optical system 10. Then, the polarization direction of the light transmitted through the first pupil region E1 and the second pupil region E2 is aligned with the first polarization direction 24. For example, a polarization filter that is provided with a polarization transmission axis Aa so as to shield s-polarized light is used as the polarizer 12. The use of the polarization filter that shields s-polarized light as the polarizer 12 makes it possible to prevent a difference in the appearance of a plurality of images obtained by light reflected from, for example, a water surface due to the reflected light.

[Optical Rotator]

FIG. 3 is a front view illustrating a schematic configuration of the optical rotator 14. As illustrated in FIG. 1, the optical rotator 14 is provided at or near the pupil position of the imaging optical system 10. Then, the optical rotator 14 rotates the light transmitted through the second pupil region E2 in the second polarization direction 26 different from the first polarization direction 24.

Materials having various optical rotatory power levels are used as the optical rotator 14. For example, an optical member that is made of quartz may be used as the optical rotator 14. In a case in which the optical rotator 14 is provided so as to have a thickness d in parallel to a crystal optical axis LC, the optical rotator 14 rotates incident linearly polarized light L1 having the first polarization direction 24 by 0 and emits linearly polarized light L2 having the second polarization direction 26.

In addition, the rotation angle (optical rotation angle) 0 of the polarization direction by the optical rotator 14 is represented by the following expression using the thickness d of the optical rotator 14 and the optical rotatory power p of crystal.

θ=d×p

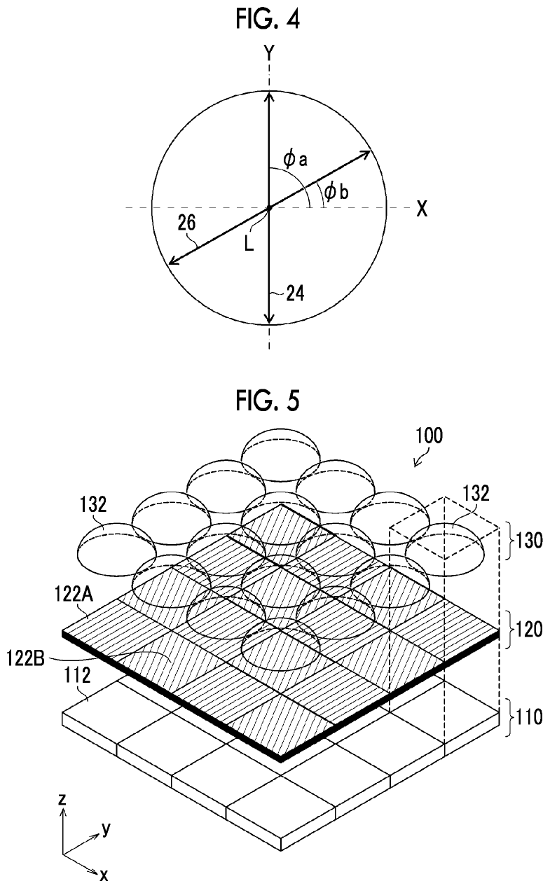

FIG. 4 is a diagram illustrating an example of the first polarization direction 24 and the second polarization direction 26.

The polarization direction is represented by an angle (Da (azimuth angle) formed between the polarization transmission axis of the polarizer 12 and the X-axis and an angle Φb (azimuth angle) formed between the polarization direction rotated by the optical rotator 14 and the X-axis in the XY plane orthogonal to an optical axis L. As illustrated in FIG. 4, the polarizer 12 is configured to transmit light having an angle Φa of 90° (azimuth angle 90°) formed between the polarization transmission axis Aa and the X-axis. That is, in the case illustrated in FIG. 4, the first polarization direction 24 is 90°. The optical rotator 14 is designed to rotate the first polarization direction 24 to the second polarization direction 26. For example, as illustrated in FIG. 3, the optical rotator 14 is designed to rotate the first polarization direction 24 to the second polarization direction 26 (azimuth angle 30°) using the relationship between the thickness d and the optical rotatory power ρ. In this case, the rotation angle θ of the optical rotator 14 is 60°. As a result, the light transmitted through the first pupil region E1 becomes light having the first polarization direction 24, and the light transmitted through the second pupil region E2 becomes light having the second polarization direction 26.

[Imaging Element]

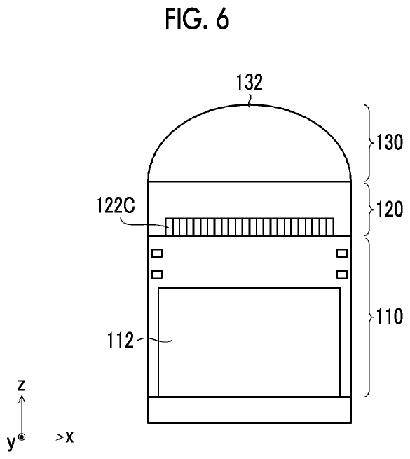

FIG. 5 is a diagram illustrating a schematic configuration of the imaging element 100 and is an exploded and enlarged view of a portion of the imaging element 100. FIG. 6 is a cross-sectional view illustrating a schematic configuration of one pixel (a portion represented by a dashed line in FIG. 5).

As illustrated in FIG. 5, the imaging element 100 has a pixel array layer 110, a polarization element array layer 120, and a microlens array layer 130.

The pixel array layer 110 is configured by two-dimensionally arranging a large number of photodiodes 112. One photodiode 112 constitutes one pixel. The photodiodes 112 are regularly arranged along the x-axis direction and the y-axis direction.

The polarization element array layer 120 is provided between the pixel array layer 110 and the microlens array layer 130. The polarization element array layer 120 is configured by two-dimensionally arranging two different types of first polarization element 122A and second polarization element 122B. The first polarization element 122A and the second polarization element 122B are arranged at the same interval as the photodiodes 112 and are comprised in each pixel. Therefore, one photodiode 112 comprises any one of the first polarization element 122A or the second polarization element 122B.

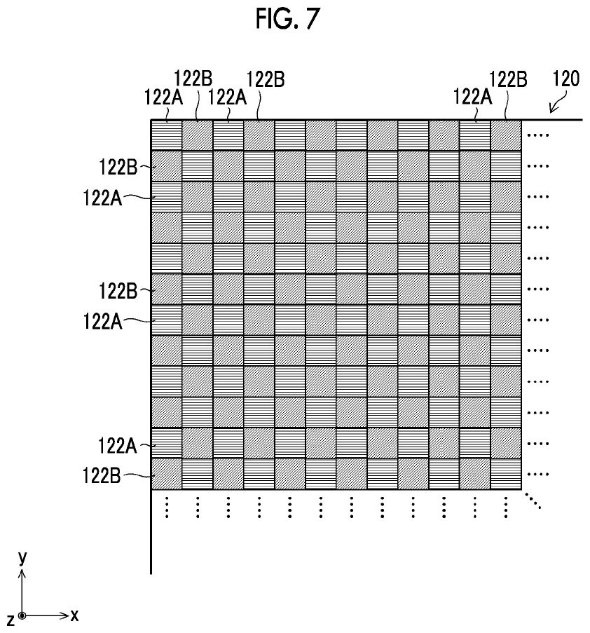

FIG. 7 is a diagram illustrating an example of the arrangement pattern of the first polarization element 122A and the second polarization element 122B.

As illustrated in FIG. 7, the two types of polarization elements 122A and 122B are regularly arranged in a predetermined order along the x-axis direction and the y-axis direction.

In the example illustrated in FIG. 7, the first polarization elements 122A and the second polarization elements 122B are regularly arranged in a predetermined pattern by alternately arranging a row in which the first polarization element 122A and the second polarization element 122B are repeatedly arranged in this order and a row in which the second polarization element 122B and the first polarization element 122A are repeatedly arranged in this order. For the first polarization elements 122A and the second polarization elements 122B arranged in this way, a set of two types of polarization elements (one first polarization element 122A and one second polarization element 122B) constitutes one unit, and the units are regularly arranged along the x-axis direction and the y-axis direction.

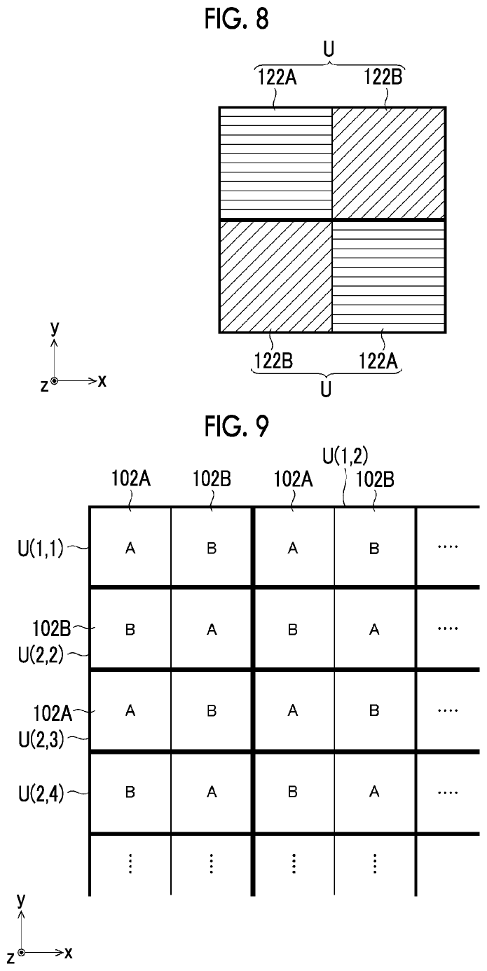

FIG. 8 is a diagram illustrating the configuration of one unit of the polarization elements.

As illustrated in FIG. 8, one unit includes one first polarization element 122A and one second polarization element 122B.

As described above, the first polarization element 122A and the second polarization element 122B have different polarization directions. In this embodiment, the first polarization element 122A is configured to transmit light having an azimuth angle of +0°. The second polarization element 122B is configured to transmit light having an azimuth angle of +45°. Therefore, the photodiode 112 comprising the first polarization element 122A receives the light (linearly polarized light) having an azimuth angle of +0°. The photodiode 112 comprising the second polarization element 122B receives the light (linearly polarized light) having an azimuth angle of +45°.

The microlens array layer 130 is configured by two-dimensionally arranging a large number of microlenses 132. Each of the microlenses 132 is disposed at the same interval as the photodiodes 112 and is comprised in each pixel. The microlens 132 is comprised in order to efficiently focus light from the imaging optical system 10 on the photodiode 112.

FIG. 9 is a diagram illustrating an example of the arrangement of the pixels in the imaging element 100.

Each pixel comprises the first polarization element 122A or the second polarization element 122B. It is assumed that the pixel (the image of A in FIG. 9) comprising the first polarization element 122A is a first pixel 102A and the pixel (the image of B in FIG. 9) comprising the second polarization element 122B is a second pixel 102B. The imaging element 100 has a plurality of units each of which is a set of two pixels including one first pixel 102A and one second pixel 102B. The unit which is a set of two pixels is referred to as a pixel unit U(x, y). As illustrated in FIG. 9, the pixel units U(x, y) are regularly arranged along the x-axis direction and the y-axis direction.

[Signal Processing Unit]

The signal processing unit 200 processes the signal output from the imaging element 100 to generate a first image corresponding to the light transmitted through the first pupil region E1 and a second image corresponding to the light transmitted through the second pupil region E2.

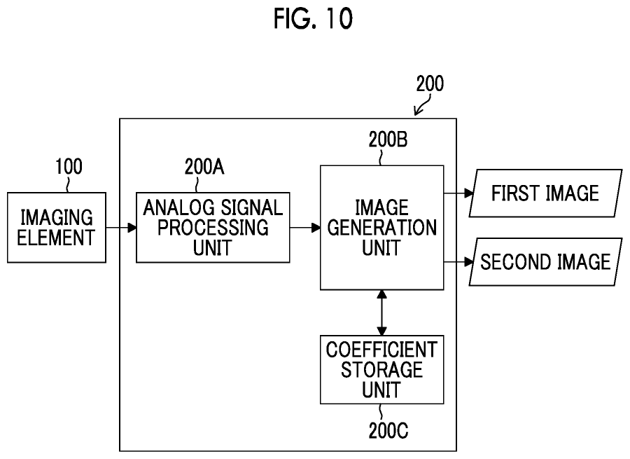

FIG. 10 is a block diagram illustrating a schematic configuration of the signal processing unit 200.

As illustrated in FIG. 10, the signal processing unit 200 includes an analog signal processing unit 200A, an image generation unit 200B, and a coefficient storage unit 200C.

The analog signal processing unit 200A acquires an analog pixel signal output from each pixel of the imaging element 100, performs predetermined signal processing (for example, a correlated double sampling process or an amplification process), converts the analog pixel signal into a digital signal, and outputs the digital signal.

The image generation unit 200B performs predetermined signal processing on the pixel signal converted into the digital signal to generate the first image and the second image corresponding to the light transmitted through the first pupil region E1 and the light transmitted through the second pupil region E2, respectively.

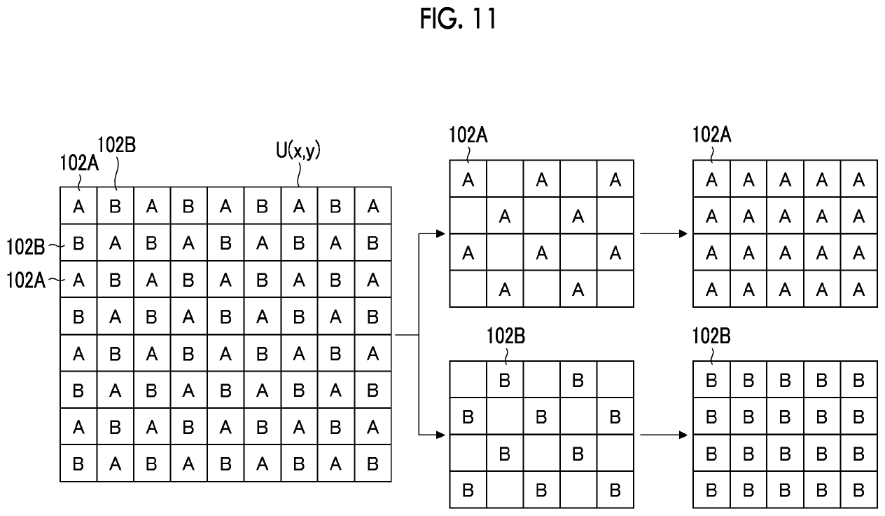

FIG. 11 is a conceptual diagram illustrating image generation.

Each pixel unit U(x, y) includes one first pixel 102A and one second pixel 102B. Therefore, two images (the first image and the second image) are generated by separating and extracting the pixel signals of the first pixel 102A and the second pixel 102B from each pixel unit U(x, y). That is, the first image configured by extracting the pixel signal of the first pixel 102A of each pixel unit U (x, y) and the second image configured by extracting the pixel signal of the second pixel 102B of each pixel unit U (x, y) are generated.

However, as described above, the light received by the first pixel 102A includes light in the first polarization direction 24 (light transmitted through the first pupil region E1) and light in the second polarization direction 26 (light transmitted through the second pupil region E2). In addition, the light received by the second pixel 102B includes light in the first polarization direction 24 (light transmitted through the first pupil region E1) and light in the second polarization direction 26 (light transmitted through the second pupil region E2). That is, the light in the first polarization direction 24 and the light in the second polarization direction 26 are incident on the first pixel 102A and the second pixel 102B while being mixed with each other.

Therefore, the image generation unit 200B performs a process of removing crosstalk (crosstalk removal process) to generate the first image corresponding to the light transmitted through the first pupil region E1 and the second image corresponding to the light transmitted through the second pupil region E2. The crosstalk removal process is performed as follows.

Here, it is assumed that the pixel signal (signal value) obtained by the first pixel 102A is x1 and the pixel signal obtained by the second pixel 102B is x2. Two pixel signals x1 and x2 are obtained from each pixel unit U(x, y). The image generation unit 200B calculates pixel signals X1 and X2 corresponding to the light in the first polarization direction 24 and the second polarization direction 26 from the two pixel signals x1 and x2 with the following Expression 1 using a matrix A to remove crosstalk.

$$A = [ \begin{matrix}a 11 & a 12 \\ a 21 & a 22\end{matrix} ] \\ [ \begin{matrix}X 1 \\ X 2\end{matrix} ] = [ \begin{matrix}a 11 & a 12 \\ a 21 & a 22\end{matrix} ] * [ \begin{matrix}x 1 \\ x 2\end{matrix} ] \qquad Expression ( 1 )$$

Hereinafter, the reason why the pixel signals X1 and X2 of the images corresponding to the light in the first polarization direction 24 and the light in the second polarization direction 26 can be calculated by Expression 1, that is, the reason why crosstalk can be removed will be described.

The ratio (the amount of crosstalk (also referred to as a crosstalk ratio)) at which the light transmitted through the first pupil region E1 and the second pupil region E2 is received by the first pixel 102A and the second pixel 102B is uniquely determined from the relationship between the polarization direction (the first polarization direction 24 and the second polarization direction 26) and the polarization directions of the first polarization element 122A and the second polarization element 122B comprised in the first pixel 102A and the second pixel 102B.

Here, assuming that the ratio at which the light in the first polarization direction 24 is received by the first pixel 102A is b11 and the ratio at which the light in the second polarization direction 26 is received by the first pixel 102A is b12, the following relationship is established between x1 and X1 and X2.

b11*X1+b12*X2=x1 (Expression 2)

Further, assuming that the ratio at which the light in the first polarization direction 24 is received by the second pixel 102B is b21 and the ratio at which the light in the second polarization direction 26 is received by the second pixel 102B is b22, the following relationship is established between x2 and X1 and X2.

b21*X1+b22*X2=x2 (Expression 3)

For X1 and X2, the simultaneous equations of Expressions 2 and 3 can be solved to acquire the pixel signals of the original images, that is, the pixel signals X1 and X2 of the image of the light in the first polarization direction 24 and the image of the light in the second polarization direction 26.

Here, the above-mentioned simultaneous equations can be represented by the following Expression 4 using a matrix B.

$$\begin{matrix}B = [ \begin{matrix}b 11 & b 12 \\ b 21 & b 22\end{matrix} ] \\ [ \begin{matrix}b 11 & b 12 \\ b 21 & b 22\end{matrix} ] * [ \begin{matrix}X 1 \\ X 2\end{matrix} ] = [ \begin{matrix}x 1 \\ x 2\end{matrix} ] & \end{matrix} \qquad Expression ( 4 )$$

X1 and X2 are calculated by multiplying both sides by an inverse matrix B⁻¹ of the matrix B.

$${[ \begin{matrix}b 11 & b 12 \\ b 21 & b 22\end{matrix} ]}^{- 1} * [ \begin{matrix}b 11 & b 12 \\ b 21 & b 22\end{matrix} ] * [ \begin{matrix}X 1 \\ X 2\end{matrix} ] = {[ \begin{matrix}b 11 & b 12 \\ b 21 & b 22\end{matrix} ]}^{- 1} * [ \begin{matrix}x 1 \\ x 2\end{matrix} ] \\ [ \begin{matrix}X 1 \\ X 2\end{matrix} ] = [ \begin{matrix}b 11 & b 12 \\ b 21 & b 22\end{matrix} ] * [ \begin{matrix}x 1 \\ x 2\end{matrix} ]$$

As described above, the pixel signal X1 of the image obtained by the light transmitted through the first pupil region E1 and the pixel signal X2 of the image obtained by the light transmitted through the second pupil region E2 are calculated from the pixel signals x1 and x2 of the first pixel 102A and the second pixel 102B on the basis of the amount of light in the first polarization direction 24 and the amount of light in the second polarization direction 26 received by the first pixel 102A and the second pixel 102B.

The matrix A in Expression 1 is the inverse matrix B⁻¹ of the matrix B (A=B⁻¹). Therefore, each element aij (i=1, 2; j=1, 2) of the matrix A can be acquired by calculating the inverse matrix B⁻¹ of the matrix B. Each element bij (i=1, 2; j=1, 2) of the matrix B is the amounts (the amount of crosstalk) of light in the first polarization direction 24 and light in the second polarization direction 26 received by the first pixel 102A and the second pixel 102B.

That is, in the first row, the element b11 is the amount (the amount of crosstalk) of light in the first polarization direction 24 received by the first pixel 102A and the element b12 is the amount of light in the second polarization direction 26 received by the first pixel 102A.

In addition, in the second row, the element b21 is the amount of light in the first polarization direction 24 received by the second pixel 102B and the element b22 is the amount of light in the second polarization direction 26 received by the second pixel 102B. The inverse matrix B⁻¹ of the matrix B exists. Therefore, the calculation of the inverse matrix B⁻¹ of the matrix B makes it possible to calculate each element of the matrix A.

The ratio (the amount of crosstalk) at which the light transmitted through the first pupil region E1 and the light transmitted through the second pupil region E2 are received by each of the pixels 102A and 102B is calculated by the square of the cosine (cos) of an angular difference between the polarization direction of the light transmitted through the first pupil region E1 and the light transmitted through the second pupil region E2 and the polarization direction of the light received by the first pixel 102A and the second pixel 102B. Therefore, for example, assuming that the polarization direction (azimuth angle) of the light (linearly polarized light) transmitted through the first pupil region E1 (or the second pupil region E2) is α and the polarization direction (azimuth angle) of the light received by an i-th pixel is β, the amount of crosstalk is calculated by cos²(|α−β|).

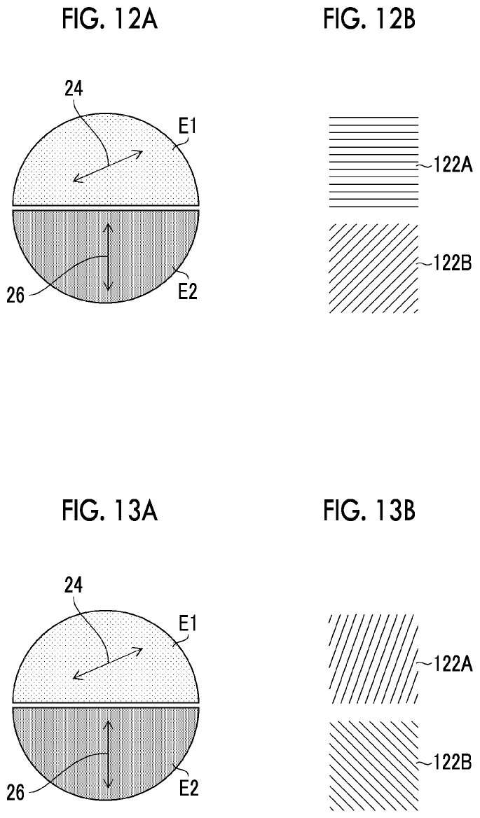

FIGS. 12A to 14B are diagrams illustrating an example of the calculation of the matrix A. In FIGS. 12A to 14B, the first polarization direction 24 of the light transmitted through the first pupil region E1 and the second polarization direction 26 of the light transmitted through the second pupil region E2 are illustrated (FIGS. 12A, 13A, and 14A). Further, in FIGS. 12A to 14B, the polarization directions of the first polarization element 122A and the second polarization element 122B are illustrated (FIGS. 12B, 13B, and 14B).

In the case illustrated in FIGS. 12A and 12B, the light transmitted through the first pupil region E1 is incident on the imaging element 100 as linearly polarized light having a polarization direction of 30°, and the light transmitted through the second pupil region E2 is incident on the imaging element 100 as linearly polarized light having a polarization direction of 90°. Further, the first polarization element 122A transmits light having a polarization direction of 0°, and the second polarization element 122B transmits light having a polarization direction of 45°.

Therefore, in this case, each element of the matrix B is as follows: b11=0.7500; b12=0.0000; b21=0.9330; and b22=0.5000.

$$B = [ \begin{matrix}0.7500 & 0.0000 \\ 0.9330 & 0.5000\end{matrix} ]$$

The inverse matrix B⁻¹ (matrix A) of the matrix B exists and has the following elements: a11=1.3333; a12=0; a21=−2.4880; and a22=2.0000.

$${B}^{- 1} = [ \begin{matrix}1.3333 & 0 \\ - 2.4880 & 2.0000\end{matrix} ] = A$$

The coefficient storage unit 200C stores, as a coefficient group, each element of the matrix A of two rows and two columns calculated as the inverse matrix B⁻¹ of the matrix B. The coefficient storage unit 200C is an example of a storage unit.

In the case illustrated in FIGS. 13A and 13B, the light transmitted through the first pupil region E1 is incident on the imaging element 100 as linearly polarized light having a polarization direction of 30°, and the light transmitted through the second pupil region E2 is incident on the imaging element 100 as linearly polarized light having a polarization direction of 90°. Further, the first polarization element 122A transmits light having a polarization direction of 60°, and the second polarization element 122B transmits light having a polarization direction of 135°.

Therefore, in this case, each element of the matrix B is as follows: b11=0.7500; b12=0.7500; b21=0.0670; and b22=0.5000.

$$B = [ \begin{matrix}0.7500 & 0.7500 \\ 0.0670 & 0.5000\end{matrix} ]$$

The inverse matrix B⁻¹ (matrix A) of the matrix B exists and has the following elements: a11=1.5396; a12=−2.3094; a21=−0.2063; and a22=2.3094.

$${B}^{- 1} = [ \begin{matrix}1.5396 & - 2.3094 \\ - 0.2063 & 2.3094\end{matrix} ] = A$$

The coefficient storage unit 200C stores, as a coefficient group, each element of the matrix A of two rows and two columns calculated as the inverse matrix B⁻¹ of the matrix B. The coefficient storage unit 200C is an example of a storage unit.

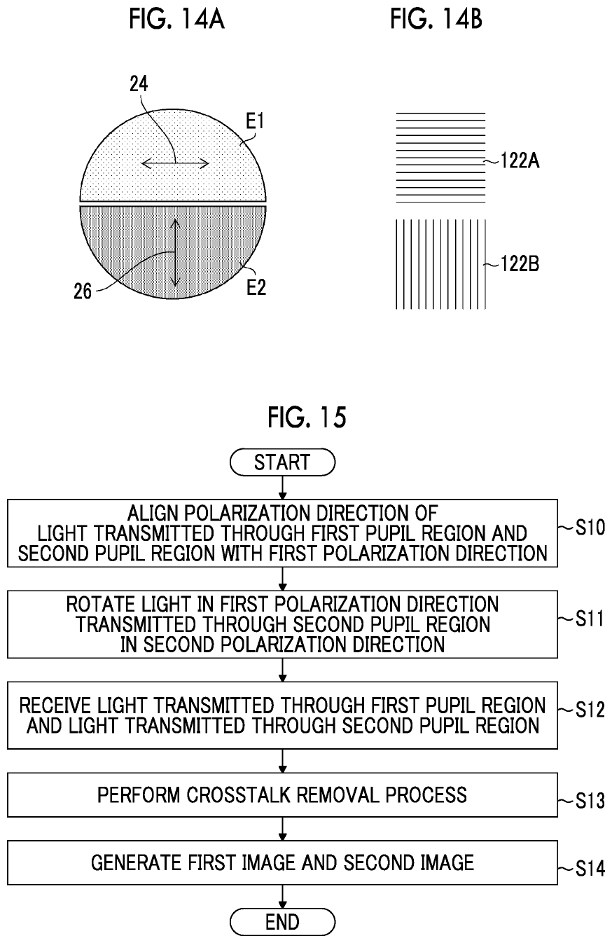

In the case illustrated in FIGS. 14A and 14B, the light transmitted through the first pupil region E1 is incident on the imaging element 100 as linearly polarized light having a polarization direction of 0°, and the light transmitted through the second pupil region E2 is incident on the imaging element 100 as linearly polarized light having a polarization direction of 90°. Further, the first polarization element 122A transmits light having a polarization direction of 0°, and the second polarization element 122B transmits light having a polarization direction of 90°. In the case illustrated in FIGS. 14A and 14B, the polarization direction (first polarization direction 24) of the light transmitted through the first pupil region E1 and the polarization direction (second polarization direction 26) of the light transmitted through the second pupil region E2 may be orthogonal to each other. In addition, the polarization direction (first polarization direction 24) of the light transmitted through the first pupil region E1 is the same as the polarization direction of the first polarization element 122A. The polarization direction (second polarization direction 26) of the light transmitted through the second pupil region E2 is the same as the polarization direction of the second polarization element 122B.

Therefore, in this case, each element of the matrix B is as follows: b11=1.0000; b12=0.0000; b21=0.0000; and b22=1.0000.

$$B = [ \begin{matrix}1.0000 & 0.0000 \\ 0.0000 & 1.0000\end{matrix} ]$$

That is, in this case, crosstalk may not occur ideally. As such, in a case in which crosstalk does not occur, it is possible to generate each image from the signals obtained from the first pixel 102A and the second pixel 102B, without performing the crosstalk removal process. That is, the pixel signal X1 of the first pupil region E1 is the pixel signal x1 of the first pixel 102A, and the pixel signal X2 of the second pupil region E2 is the pixel signal x2 of the first pixel 102A.

The image generation unit 200B acquires the coefficient group from the coefficient storage unit 200C, calculates two pixel signals X1 and X2 corresponding to the light in the first polarization direction 24 and the light in the second polarization direction 26 from two pixel signals x1 and x2 obtained from each pixel unit U (x, y) using Expression 1, and generates the image of the light in the first polarization direction 24 and the image of the light in the second polarization direction 26. The image generation unit 200B is an example of an arithmetic unit.

The images corresponding to the light in the first polarization direction 24 and the second polarization direction 26 generated by the image generation unit 200B are output to the outside and are stored in a storage device as needed. In addition, the images are displayed on a display (not illustrated) as needed.

FIG. 15 is a flowchart illustrating the processing flow of an imaging method using the imaging device 1.

First, the polarizer 12 aligns the polarization direction of the light transmitted through the first pupil region E1 and the second pupil region E2 with the first polarization direction 24 (Step S10). Then, the optical rotator 14 rotates the first polarization direction 24 of the light transmitted through the second pupil region E2 to the second polarization direction 26 (Step S11). Then, the first pixel 102A and the second pixel 102B receive the light transmitted through the first pupil region E1 and the light transmitted through the second pupil region E2 (Step S12). Then, the image generation unit 200B performs the crosstalk removal process on the pixel signals obtained from the first pixel 102A and the second pixel 102B (Step S13). Further, in a case in which the first polarization direction 24 and the second polarization direction 26 are orthogonal to each other, the polarization direction of the first polarization element 122A corresponds to the first polarization direction 24, and the polarization direction of the second polarization element 122B corresponds to the second polarization direction 26, crosstalk does not occur ideally, and the crosstalk removal process may not be performed. Then, the image generation unit 200B generates the first image and the second image on the basis of the pixel signal of the first pixel 102A and the pixel signal of the second pixel 102B subjected to the crosstalk removal process (Step S14).

According to the above-described embodiment, even in a case in which two different images are generated on the basis of light having two different polarization directions, the polarizer 12 aligns the polarization of the pupil region E once. Therefore, it is possible to generate the images between which the difference in appearance caused by the difference between the polarization directions of the received light is suppressed.

### Second Embodiment

Next, a second embodiment of the invention will be described. In this embodiment, a wavelength filter (bandpass filter) 40 is provided, and it is possible to independently obtain images of each wavelength band.

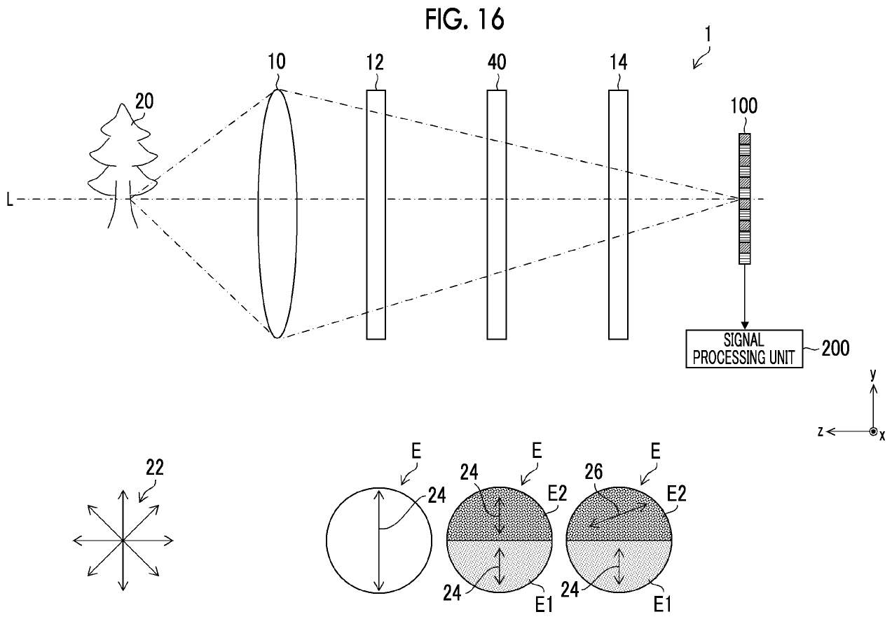

FIG. 16 is a diagram illustrating a schematic configuration of an imaging device 1 according to this embodiment. In addition, the portions already described in FIG. 1 are denoted by the same reference numerals, and the description thereof will not be repeated.

As illustrated in FIG. 16, the imaging device 1 according to this embodiment comprises an imaging optical system 10, a polarizer 12, the wavelength filter 40, an optical rotator (first optical rotator) 14, an imaging element 100, and a signal processing unit 200. Further, the position where the wavelength filter 40 is provided is not limited to between the polarizer 12 and the optical rotator 14 and is not particularly limited as long as light transmitted through the first pupil region E1 and light transmitted through the second pupil region E2 can be appropriately incident. Light transmitted through the wavelength filter 40 becomes light in different wavelength bands in the first pupil region E1 and the second pupil region E2 (illustrated below the wavelength filter 40).

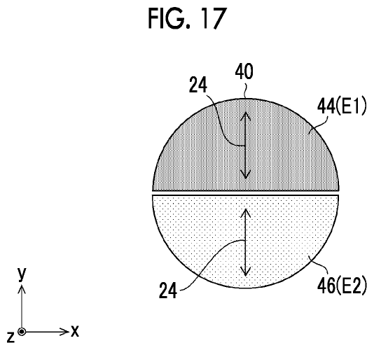

FIG. 17 is a front view illustrating a schematic configuration of the wavelength filter 40.

For example, the wavelength filter 40 transmits light in different wavelength bands in the first pupil region E1 and the second pupil region E2. Specifically, a region 44 corresponding to the first pupil region E1 and a region 46 corresponding to the second pupil region E2 transmit light in different wavelength bands. The wavelength filter 40 causes the first image corresponding to the light transmitted through the first pupil region E1 to become an image based on the light in the wavelength band (first wavelength band) transmitted through the region 44 and causes the second image corresponding to the light transmitted through the second pupil region E2 to become an image based on the light in the wavelength band (second wavelength band) transmitted through the region 46. In addition, FIG. 17 illustrates an example of the wavelength filter 40 in a case in which the pupil region E of the imaging optical system 10 is divided into the first pupil region E1 and the second pupil region E2. The wavelength filter 40 integrally comprises a first wavelength filter (first wavelength band) and a second wavelength filter (second wavelength band). In a case in which the pupil region E of the imaging optical system 10 is divided into a first pupil region E1, a second pupil region E2, and a third pupil region E3 (third embodiment) which will be described below, a wavelength filter 40 that transmits three different wavelength bands (a first wavelength band, a second wavelength band, and a third wavelength band) is used. Further, a wavelength filter 40 that integrally comprises a first wavelength filter, a second wavelength filter, and a third wavelength filter may be used. Alternatively, the first wavelength filter, the second wavelength filter, and the third wavelength filter may be provided separately. The images of a plurality of wavelength bands obtained in this way are appropriately applied to, for example, a fruit sugar content test, a food growth test, and a water quality test using spectral reflectance.

According to this embodiment described above, it is possible to independently generate the images of different wavelength bands. In addition, it is possible to generate the images between which the difference in appearance caused by the difference between the polarization directions of the received light is suppressed.

### Third Embodiment

Next, a third embodiment of the invention will be described. In this embodiment, three different polarization directions (a first polarization direction 24, a second polarization direction 26, and a third polarization direction 28) are used to independently acquire three images.

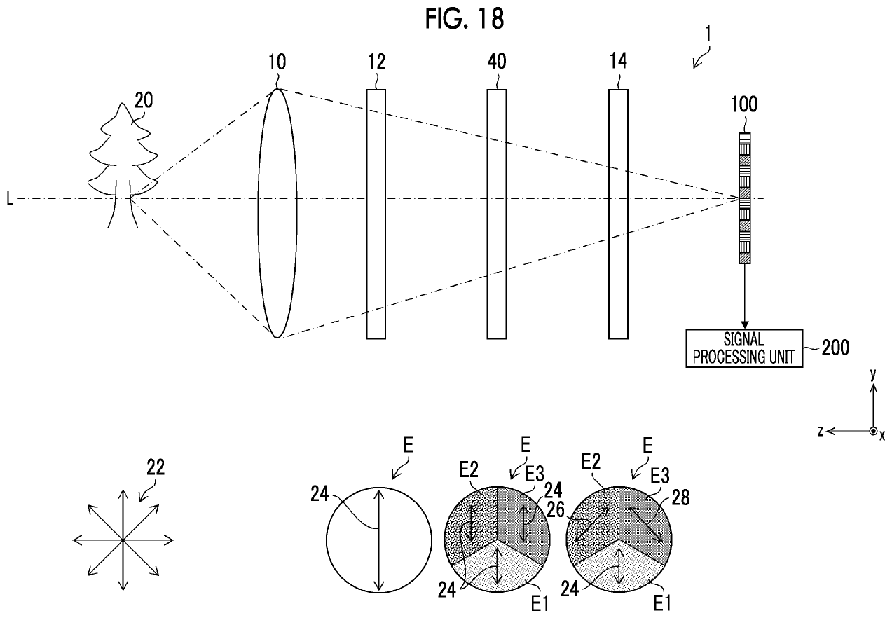

FIG. 18 is a diagram illustrating a schematic configuration of an imaging device 1 according to the third embodiment. In addition, the portions already described in FIGS. 1 and 16 are denoted by the same reference numerals, and the description thereof will not be repeated.

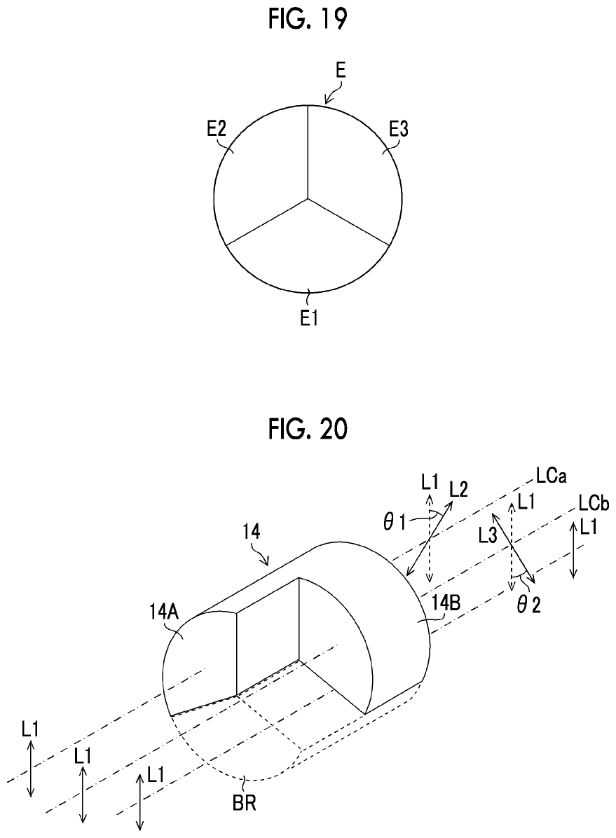

As illustrated in FIG. 18, the imaging device 1 according to this embodiment comprises an imaging optical system 10, a polarizer 12, a wavelength filter 40, an optical rotator 14, an imaging element 100, and a signal processing unit 200. In addition, FIG. 19 illustrates a polarization direction 22 of natural light reflected by an object 20, the first polarization direction 24 which is the polarization direction of light transmitted through the polarizer 12, the second polarization direction 26 which is the polarization direction of light transmitted through the optical rotator 14, and the third polarization direction 28. Further, even in a case in which three images are independently acquired using three different polarization directions, a crosstalk removal process and image generation are similarly performed by applying the above-mentioned method in a case in which two images are acquired.

FIG. 19 is a front view illustrating a conceptual pupil region E of the imaging optical system 10.

The pupil region E according to this embodiment includes a first pupil region E1, a second pupil region E2, and a third pupil region E3. For example, the first pupil region E1, the second pupil region E2, and the third pupil region E3 are regions obtained by equally dividing the pupil region E at an angle of 120°.

FIG. 20 is a front view illustrating a schematic configuration of the optical rotator 14 according to this embodiment. In addition, the portions already described in FIG. 3 are denoted by the same reference numerals, and the description thereof will not be repeated. Further, FIG. 20 illustrates a crystal optical axis LCa of a first optical rotation portion 14A and a crystal optical axis LCb of a second optical rotation portion 14B.

The optical rotator 14 includes the first optical rotation portion (first optical rotator) 14A and the second optical rotation portion (second optical rotator) 14B. The first optical rotation portion 14A and the second optical rotation portion 14B have different thicknesses and different optical rotatory power levels. In addition, the optical rotator 14 corresponds to the first pupil region E1, the second pupil region E2, and the third pupil region E3. Light transmitted through the second pupil region E2 is incident on the first optical rotation portion 14A, and light transmitted through the third pupil region E3 is incident on the second optical rotation portion 14B. Further, light transmitted through the first pupil region E1 is transmitted through a blank portion BR in the optical rotator 14, and the polarization direction of the light does not change.

The first optical rotation portion 14A rotates incident linearly polarized light L1 having the first polarization direction 24 by 01 and emits linearly polarized light L2 having the second polarization direction 26. In addition, the second optical rotation portion 14B rotates incident linearly polarized light L1 having the first polarization direction 24 by 02 and emits linearly polarized light L3 having the third polarization direction 28. Further, in FIG. 20, an example of the optical rotator 14 in which the first optical rotation portion 14A and the second optical rotation portion 14B are integrated has been described. However, the invention is not limited to this example. For example, an optical rotator 14 having the first optical rotation portion 14A and an optical rotator 14 having the second optical rotation portion 14B may be provided independently.

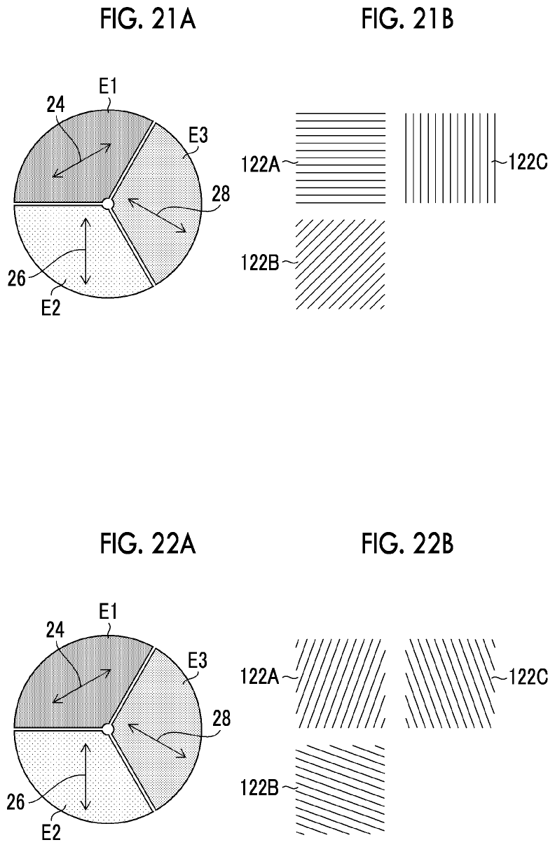

FIGS. 21A to 22B are diagrams illustrating examples of the calculation of the above-mentioned matrix A. In FIGS. 21A to 22B, the first polarization direction 24 of the light transmitted through the first pupil region E1, the second polarization direction 26 of the light transmitted through the second pupil region E2, and the third polarization direction 28 of the light transmitted through the third pupil region E3 are illustrated (FIGS. 21A and 22A). Further, in FIGS. 21A to 22B, the polarization directions of a first polarization element 122A, a second polarization element 122B, and a third polarization element 122C are illustrated (FIGS. 21B and 22B). In addition, the imaging element 100 according to this embodiment has a plurality of pixel units which receive the light transmitted through the first pupil region E1, the second pupil region E2, and the third pupil region E3 and each of which is a set of a first pixel, a second pixel, and a third pixel that receive light in different polarization directions.

In the case illustrated in FIGS. 21A and 21B, the light transmitted through the first pupil region E1 is incident on the imaging element 100 as linearly polarized light having a polarization direction of 30°, the light transmitted through the second pupil region E2 is incident on the imaging element 100 as linearly polarized light having a polarization direction of 90°, and the light transmitted through the third pupil region E3 is incident on the imaging element 100 as linearly polarized light having a polarization direction of 150°. Further, the first polarization element 122A transmits light having a polarization direction of 0°, the second polarization element 122B transmits light having a polarization direction of 45°, and the third polarization element 122C transmits light having a polarization direction of 90°.

Therefore, in this case, each element of the matrix B is as follows: b11=0.7500; b12=0.0000; b13=0.7500; b21=0.9330; b22=0.5000; b23=0.0670; b31=0.2500; b32=1.0000; and b33=0.2500.

$$B = [ \begin{matrix}0.7500 & 0.0000 & 0.7500 \\ 0.9330 & 0.5000 & 0.0670 \\ 0.2500 & 1.0000 & 0.2500\end{matrix} ]$$

The inverse matrix B⁻¹ (matrix A) of the matrix B exists, and each element thereof is as follows: a11=0.0893; a12=1.1547; a13=−0.5774; a21=−0.3333; a22=0.0000; a23=1.0000; a31=1.2440; a32=−1.1547; and A33=0.5774.

$${B}^{- 1} = [ \begin{matrix}0.0893 & 1.1547 & - 0.5774 \\ - 0.3333 & 0.0000 & 1.0000 \\ 1.2440 & - 1.1547 & 0.5774\end{matrix} ] = A$$

In the case illustrated in FIGS. 22A and 22B, the light transmitted through the first pupil region E1 is incident on the imaging element 100 as linearly polarized light having a polarization direction of 30°, the light transmitted through the second pupil region E2 is incident on the imaging element 100 as linearly polarized light having a polarization direction of 90°, and the light transmitted through the third pupil region E3 is incident on the imaging element 100 as linearly polarized light having a polarization direction of 150°. Further, the first polarization element 122A transmits light having a polarization direction of 60°, the second polarization element 122B transmits light having a polarization direction of 150°, and the third polarization element 122C transmits light having a polarization direction of 105°.

Therefore, in this case, each element of the matrix B is as follows: b11=0.7500; b12=0.7500; b13=0.0000; b21=0.2500; b22=0.2500; b23=1.0000; b31=0.0670; b32=0.9330; and b33=0.5000.

$$B = [ \begin{matrix}0.7500 & 0.7500 & 0.0000 \\ 0.2500 & 0.2500 & 1.0000 \\ 0.0670 & 0.9330 & 0.5000\end{matrix} ]$$

The inverse matrix B⁻¹ (matrix A) of the matrix B exists, and each element thereof is as follows: a11=1.2440; a12=0.5774; a13=−1.1547; a21=0.0893; a22=−0.5774; a23=1.1547; a31=−0.3333; a32=1.0000; and A33=0.0000.

$${B}^{- 1} = [ \begin{matrix}1.2440 & 0.5774 & - 1.1547 \\ 0.0893 & - 0.5774 & 1.1547 \\ - 0.3333 & 1.0000 & 0.0000\end{matrix} ] = A$$

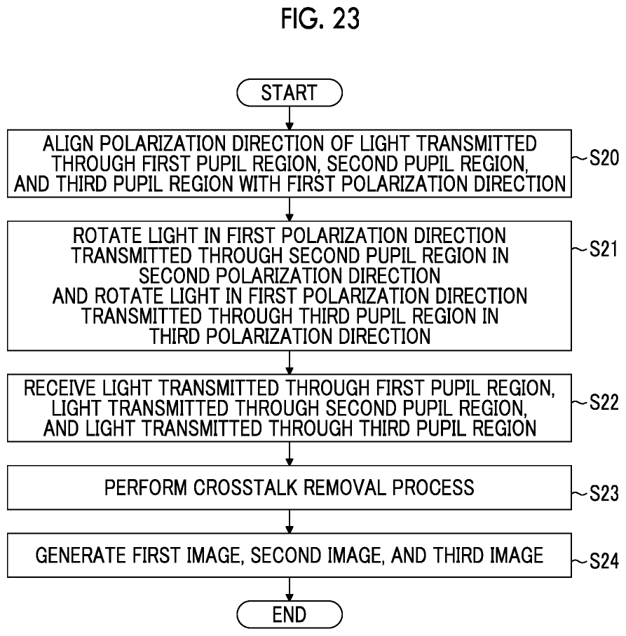

FIG. 23 is a flowchart illustrating the processing flow of an imaging method using the imaging device 1.

First, the polarizer 12 aligns the polarization directions of the light transmitted through the first pupil region E1, the second pupil region E2, and the third pupil region E3 with the first polarization direction 24 (Step S20). Then, the optical rotation portion 14A of the optical rotator 14A rotates the first polarization direction 24 of the light transmitted through the second pupil region E2 to the second polarization direction 26, and the optical rotation portion 14B of the optical rotator 14 rotates the first polarization direction 24 of the light transmitted through the third pupil region E3 to the third polarization direction 28 (Step S21). Then, the imaging element 100 receives the light transmitted through the first pupil region E1, the light transmitted through the second pupil region E2, and the light transmitted through the third pupil region E3 (Step S22). Then, the image generation unit 200B performs the crosstalk removal process (Step S23). Then, the image generation unit 200B generates the first image, the second image, and the third image (Step S24).

According to this embodiment described above, even in a case in which three images are independently generated on the basis of light having three different polarization directions, it is possible to generate the images between which the difference in appearance caused by the difference between the polarization directions of the received light is suppressed.

### Fourth Embodiment

Next, a fourth embodiment of the invention will be described. In this embodiment, the optical rotator 14 rotates all of the light transmitted through the first pupil region E1 and the second pupil region E2, or the first pupil region E1, the second pupil region E2, and the third pupil region E3.

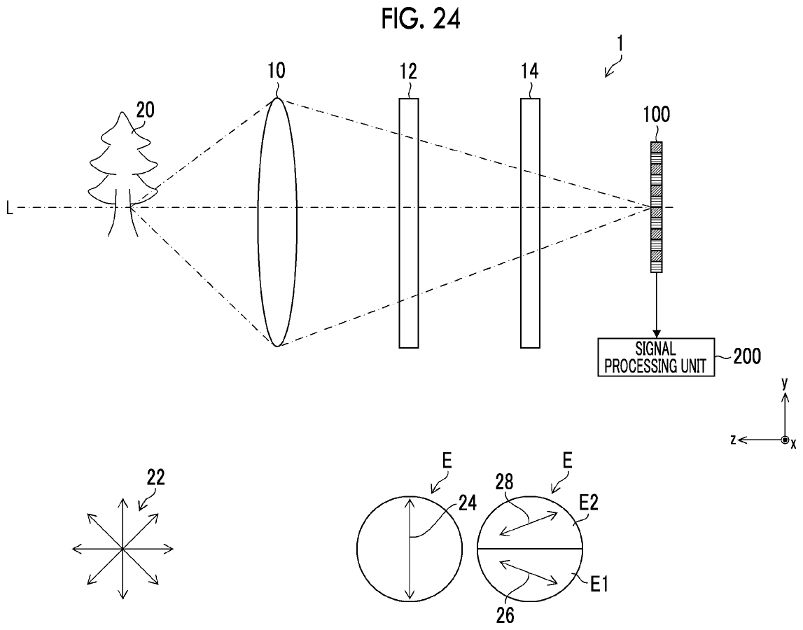

FIG. 24 is a diagram illustrating a schematic configuration of an imaging device 1 according to the fourth embodiment. In addition, the portions already described in FIG. 1 are denoted by the same reference numerals, and the description thereof will not be repeated.

In the case illustrated in FIG. 24, the optical rotator 14 rotates the first polarization direction 24 of the light transmitted through the first pupil region E1 to a second polarization direction 26 and rotates the first polarization direction 24 of the light transmitted through the second pupil region E2 to a third polarization direction 28. That is, the optical rotator 14 has optical rotation portions having different optical rotation power levels in portions corresponding to the first pupil region E1 and the second pupil region E2 and rotates incident linearly polarized light. Specifically, the first optical rotation portion (first optical rotator) of the optical rotator 14 rotates the light transmitted through the first pupil region E1 from the first polarization direction 24 to the second polarization direction 26. In addition, the second optical rotation portion (second optical rotator) of the optical rotator 14 rotates the light transmitted through the second pupil region E2 from the first polarization direction 24 to the third polarization direction 28. Further, the optical rotator 14 may have the first optical rotation portion and the second optical rotation portion as an integral optical rotator or as separate optical rotators.

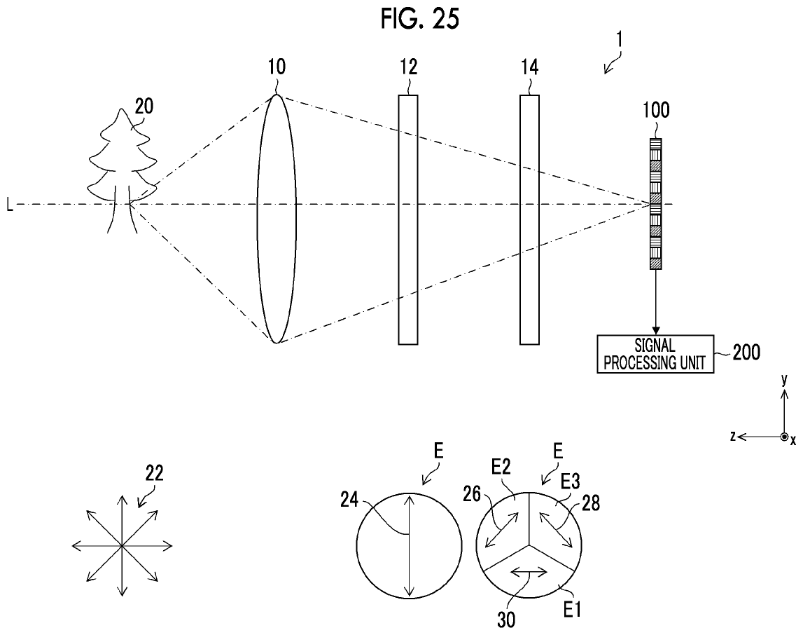

FIG. 25 is a diagram illustrating a schematic configuration of another example of the imaging device 1 according to this embodiment. In addition, the portions already described in FIG. 18 are denoted by the same reference numerals, and the description thereof will not be repeated.

In the case illustrated in FIG. 25, an optical rotator 14 rotates the first polarization direction 24 of the light transmitted through the first pupil region E1 to the second polarization direction 26, rotates the first polarization direction 24 of the light transmitted through the second pupil region E2 to the third polarization direction 28, and rotates the first polarization direction 24 of the light transmitted through the third pupil region E3 to a fourth polarization direction 30. That is, the optical rotator 14 has optical rotation portions having different optical rotatory power levels in portions corresponding to the first pupil region E1, the second pupil region E2, and the third pupil region E3, and rotates incident linearly polarized light. Specifically, the first optical rotation portion (first optical rotator) of the optical rotator 14 rotates the light transmitted through the first pupil region E1 from the first polarization direction 24 to the second polarization direction 26. In addition, the second optical rotation portion (second optical rotator) of the optical rotator 14 rotates the light transmitted through the second pupil region E2 from the first polarization direction 24 to the third polarization direction 28. Further, the third optical rotation portion (third optical rotator) of the optical rotator 14 rotates the light transmitted through the third pupil region E3 from the first polarization direction 24 to the fourth polarization direction 30. In addition, the optical rotator 14 may have the first optical rotation portion, the second optical rotation portion, and the third optical rotation portion as an integral optical rotator or separate optical rotators.

According to this embodiment described above, it is possible to generate images on the basis of light in various polarization directions without being limited to the polarization directions aligned by the polarizer 12. In addition, it is possible to generate the images between which the difference in appearance caused by the difference between the polarization directions of the received light is suppressed.

The examples of the invention have been described above. However, the invention is not limited to the above-described embodiments, and various modifications can be made without departing from the spirit of the invention.

### EXPLANATION OF REFERENCES

1: imaging device
10: Imaging optical system
12: polarizer
14: optical rotator
20: object
40: wavelength filter
100: imaging element
102A: first pixel
102B: second pixel
110: pixel array layer
112: photodiode
120: polarization element array layer
122A: first polarization element
122B: second polarization element
122C: third polarization element
130: microlens array layer
132: microlens
200: signal processing unit
200A: analog signal processing unit
200B: image generation unit
200C: coefficient storage unit

What is claimed is:

1. An imaging device comprising:
an imaging optical system that has a pupil region including a first pupil region and a second pupil region different from the first pupil region;
a polarizer that aligns a polarization direction of light transmitted through the first pupil region and the second pupil region with a first polarization direction;
a first optical rotator that rotates the light, which has been transmitted through the second pupil region and has been aligned in the first polarization direction, in a second polarization direction different from the first polarization direction;
an imaging element that receives the light transmitted through the first pupil region and the second pupil region and has a plurality of pixel units each of which is a set of a first pixel and a second pixel receiving light in different polarization directions; and
an image generation unit that performs a crosstalk removal process on pixel signals of the first pixel and the second pixel and generates a first image corresponding to the light transmitted through the first pupil region and a second image corresponding to the light transmitted through the second pupil region on the basis of the pixel signals subjected to the crosstalk removal process.

2. The imaging device according to claim 1, further comprising:
a second optical rotator that rotates the light, which has been transmitted through the first pupil region and has been aligned in the first polarization direction, in a third polarization direction different from the first polarization direction and the second polarization direction.

3. The imaging device according to claim 1, further comprising:
a first wavelength filter that transmits light in a first wavelength band in the light transmitted through the first pupil region; and
a second wavelength filter that transmits light in a second wavelength band in the light transmitted through the second pupil region.

4. An imaging device comprising:
an imaging optical system that has a pupil region including a first pupil region and a second pupil region different from the first pupil region;
a polarizer that aligns a polarization direction of light transmitted through the first pupil region and the second pupil region with a first polarization direction;
a first optical rotator that rotates the light, which has been transmitted through the second pupil region and has been aligned in the first polarization direction, in a second polarization direction orthogonal to the first polarization direction;
an imaging element that receives the light transmitted through the first pupil region and the second pupil region and has a plurality of pixel units each of which is a set of a first pixel receiving light in the first polarization direction and a second pixel receiving light in the second polarization direction; and
an image generation unit that generates a first image corresponding to the light transmitted through the first pupil region and a second image corresponding to the light transmitted through the second pupil region on the basis of pixel signals of the first pixel and the second pixel.

5. The imaging device according to claim 4, further comprising:
a first wavelength filter that transmits light in a first wavelength band in the light transmitted through the first pupil region; and
a second wavelength filter that transmits light in a second wavelength band in the light transmitted through the second pupil region.

6. An imaging device comprising:
an imaging optical system that has a pupil region including a first pupil region, a second pupil region different from the first pupil region, and a third pupil region different from the first and second pupil regions;
a polarizer that aligns a polarization direction of light transmitted through the first pupil region, the second pupil region, and the third pupil region with a first polarization direction;
a first optical rotator that rotates the light, which has been transmitted through the second pupil region and has been aligned in the first polarization direction, in a second polarization direction different from the first polarization direction;
a second optical rotator that rotates the light, which has been transmitted through the third pupil region and has been aligned in the first polarization direction, in a third polarization direction different from the first polarization direction and the second polarization direction;
an imaging element that receives the light transmitted through the first pupil region, the second pupil region, and the third pupil region and has a plurality of pixel units each of which is a set of a first pixel, a second pixel, and a third pixel receiving light in different polarization directions; and
an image generation unit that performs a crosstalk removal process on pixel signals of the first pixel, the second pixel, and the third pixel and generates a first image corresponding to the light transmitted through the first pupil region, a second image corresponding to the light transmitted through the second pupil region, and a third image corresponding to the light transmitted through the third pupil region on the basis of the pixel signals subjected to the crosstalk removal process.

7. The imaging device according to claim 6, further comprising:
a third optical rotator that rotates the light, which has been transmitted through the first pupil region and has been aligned in the first polarization direction, in a fourth polarization direction different from the first polarization direction, the second polarization direction, and the third polarization direction.

8. The imaging device according to claim 6, further comprising:
a first wavelength filter that transmits light in a first wavelength band in the light transmitted through the first pupil region;
a second wavelength filter that transmits light in a second wavelength band in the light transmitted through the second pupil region; and
a third wavelength filter that transmits light in a third wavelength band in the light transmitted through the third pupil region.

9. The imaging device according to claim 1,
wherein the polarizer shields s-polarized light.

10. The imaging device according to claim 1,
wherein, in the imaging element, the pixel unit includes a pixel including a polarization element.

11. The imaging device according to claim 10,
wherein, in the imaging element, the polarization element is provided between a photodiode and a microlens which constitute the pixel.

12. An imaging method comprising:
a step of causing a polarizer to align a polarization direction of light transmitted through a first pupil region and a second pupil region of an imaging optical system, which has a pupil region including the first pupil region and the second pupil region different from the first pupil region, with a first polarization direction;
a step of causing a first optical rotator to rotate the light, which has been transmitted through the second pupil region and has been aligned in the first polarization direction, in a second polarization direction different from the first polarization direction; and
a step of performing a crosstalk removal process on pixel signals of a first pixel and a second pixel of an imaging element, which receives the light transmitted through the first pupil region and the second pupil region and has a plurality of pixel units each of which is a set of the first pixel and the second pixel receiving light in different polarization directions, and generating a first image corresponding to the light transmitted through the first pupil region and a second image corresponding to the light transmitted through the second pupil region on the basis of the pixel signals subjected to the crosstalk removal process.

13. The imaging method according to claim 12,
wherein a second optical rotator rotates the light, which has been transmitted through the first pupil region and has been aligned in the first polarization direction, in a third polarization direction different from the first polarization direction and the second polarization direction.

14. An imaging method comprising:
a step of causing a polarizer to align a polarization direction of light transmitted through a first pupil region, a second pupil region, and a third pupil region of an imaging optical system, which has a pupil region including the first pupil region, the second pupil region different from the first pupil region, and the third pupil region different from the first and second pupil regions, with a first polarization direction;
a step of causing a first optical rotator to rotate the light, which has been transmitted through the second pupil region and has been aligned in the first polarization direction, in a second polarization direction different from the first polarization direction;
a step of causing a second optical rotator to rotate the light, which has been transmitted through the third pupil region and has been aligned in the first polarization direction, in a third polarization direction different from the first polarization direction and the second polarization direction; and
a step of performing a crosstalk removal process on pixel signals of a first pixel, a second pixel, and a third pixel of an imaging element, which receives the light transmitted through the first pupil region, the second pupil region, and the third pupil region and has a plurality of pixel units each of which is a set of the first pixel, the second pixel, and the third pixel receiving light in different polarization directions, and generating a first image corresponding to the light transmitted through the first pupil region, a second image corresponding to the light transmitted through the second pupil region, and a third image corresponding to the light transmitted through the third pupil region on the basis of the pixel signals subjected to the crosstalk removal process.

15. The imaging method according to claim 14,
wherein a third optical rotator rotates the light, which has been transmitted through the first pupil region and has been aligned in the first polarization direction, in a fourth polarization direction different from the first polarization direction, the second polarization direction, and the third polarization direction.

16. An imaging method comprising:
a step of causing a polarizer to align a polarization direction of light transmitted through a first pupil region and a second pupil region of an imaging optical system, which has a pupil region including the first pupil region and the second pupil region different from the first pupil region, with a first polarization direction;
a step of causing a first optical rotator to rotate the light, which has been transmitted through the second pupil region and has been aligned in the first polarization direction, in a second polarization direction orthogonal to the first polarization direction; and
a step of generating a first image corresponding to the light transmitted through the first pupil region and a second image corresponding to the light transmitted through the second pupil region on the basis of pixel signals of a first pixel and a second pixel of an imaging element which receives the light transmitted through the first pupil region and the second pupil region and has a plurality of pixel units each of which is a set of the first pixel receiving light in the first polarization direction and the second pixel receiving light in the second polarization direction.
